(19) United States
(12) Patent Application Publication
(10) Pub. No.: US 2015/0081385 A1
(43) Pub. Date: Mar. 19, 2015

(54) System and Method for Determining Political Representation

(71) Applicant: George Brent Richardson, Clemmons, NC (US)

(72) Inventor: George Brent Richardson, Clemmons, NC (US)

(21) Appl. No.: 14/030,007

(22) Filed: Sep. 18, 2013

(51) Int. Cl. G06Q 30/02; G06Q 50/26

(52) U.S. Cl. CPC G06Q 30/0203; G06Q 50/26
USPC 705/7.32

(57) ABSTRACT

A computer-implemented method for determining representation by political figures. The method can include compiling a list of political issues, receiving preferences of a plurality of voters for at least one issue in the list of political issues, determining a stance of a political figure for the at least one issue, and determining if the stance of the political figure matches a preference of the plurality of voters for the at least one issue.

### BACKGROUND

Rapidly changing views on certain political issues can leave elected officials and candidates for political office out of touch with their constituents. Additionally, it may not be simple for a voter to determine the stances of political figures on all the issues that are important to the voter. It is therefore possible that a voter may choose a candidate which does not accurately represent the voter on important issues while agreeing with the voter on less important issues. Therefore, a simple way to determine political representation is desired.

### SUMMARY

According to at least one exemplary embodiment, a computer-implemented method for determining representation by political figures may be described. The method can include compiling a list of political issues, receiving preferences of a plurality of voters for at least one issue in the list of political issues, determining a stance of a political figure for the at least one issue, and determining if the stance of the political figure matches a preference of the plurality of voters for the at least one issue.

According to another exemplary embodiment, a computer-implemented method for matching a voter and a political figure may be described. The method can include receiving a plurality of political issues from a voter, receiving preferences of the voter for at least one political issue of the plurality of political issues, receiving importance rankings for at least one political issue of the plurality of political issues, determining stances of a plurality of political figures for at least one political issue of the plurality of political issues, determining matches between the preferences of the voter and the stance of each political figure of the plurality of political figures, and providing a ranking to the voter for each political figure based on the matches.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1a is a diagram of an exemplary computer system.

FIG. 1b is a diagram of an exemplary system for determining political representation.

FIG. 2 shows an exemplary method for determining voter preferences.

FIG. 3 shows an exemplary method for determining a stance of a political figure.

FIG. 4 shows an exemplary method for determining representation by a political figure of their constituency.

FIG. 5 shows an exemplary method of matching a voter to a political figure.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

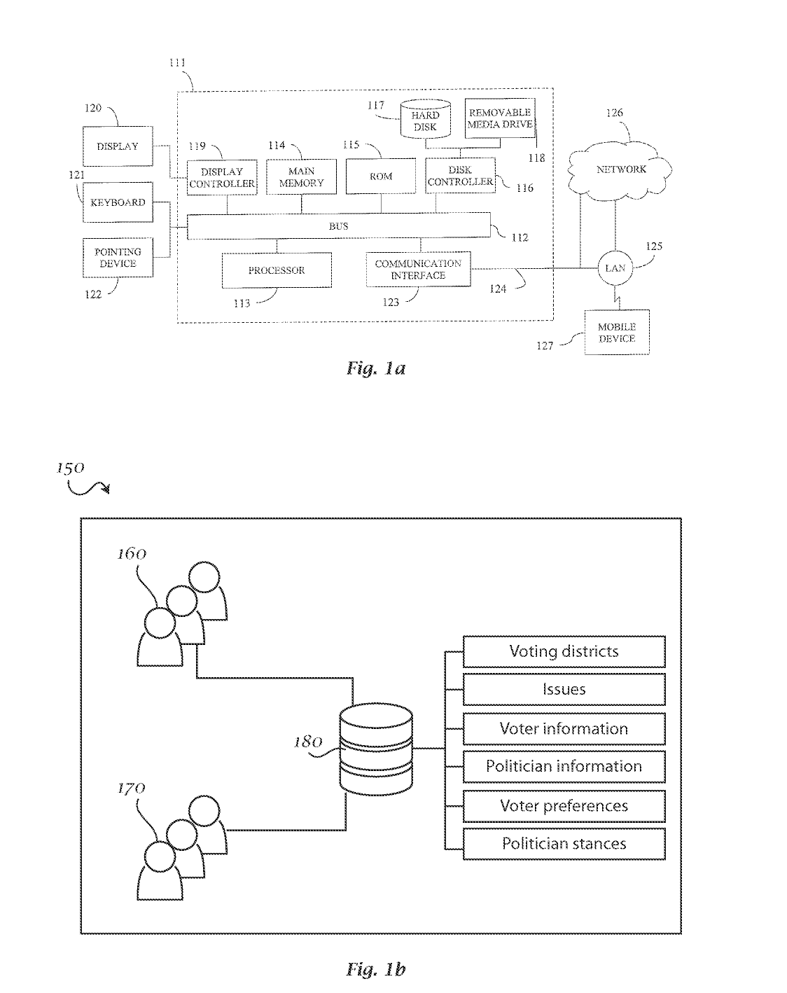

FIG. 1a illustrates a computer system 111 upon which an embodiment of the present invention may be implemented. The computer system 111 includes a bus 112 or other communication mechanism for communicating information, and a processor 113 coupled with the bus 112 for processing the information. The computer system 111 also includes a main memory 114, such as a random access memory (RAM) or other dynamic storage device (e.g., dynamic RAM (DRAM), static RAM (SRAM), and synchronous DRAM (SDRAM)), coupled to the bus 112 for storing information and instructions to be executed by processor 113. In addition, the main memory 114 may be used for storing temporary variables or other intermediate information during the execution of instructions by the processor 113. The computer system 111 further includes a read only memory (ROM) 115 or other static storage device (e.g., programmable ROM (PROM), erasable PROM (EPROM), and electrically erasable PROM (EEPROM)) coupled to the bus 112 for storing static information and instructions for the processor 113.

The computer system 111 also includes a disk controller 116 coupled to the bus 112 to control one or more storage devices for storing information and instructions, such as a magnetic hard disk 117, and a removable media drive 118 (e.g., floppy disk drive, read-only compact disc drive, read/write compact disc drive, compact disc jukebox, tape drive, removable magneto-optical drive, flash drive, and the like). The storage devices may be added to the computer system 111 using an appropriate device interface (e.g., small computer system interface (SCSI), integrated device electronics (IDE), enhanced-IDE (E-IDE), direct memory access (DMA), or ultra-DMA).

Further, exemplary embodiments include or incorporate at least one database which may store software, descriptive data, system data, digital images and any other data item required by the other components necessary to effectuate any embodiment of the present system known to one having ordinary skill in the art. The database may be provided, for example, as a database management system (DBMS), a relational database management system (e.g., DB2, ACCESS, etc.), an object-oriented database management system (ODBMS), a file system or another conventional database package as a few non-limiting examples. The database can be accessed via a Structure Query Language (SQL) or other tools known to one having skill in the art.

Still referring to FIG. 1, the computer system 111 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 111 may also include a display controller 119 coupled to the bus 112 to control a display 120, such as a cathode ray tube (CRT), liquid crystal display (LCD) or any other type of display, for displaying information to a computer client 204. The computer system includes input devices, such as a keyboard 121 and a pointing device 122, for interacting with a computer client and providing information to the processor 113. Additionally, a touch screen could be employed in conjunction with display 120. The pointing device 122, for example, may be a mouse, a trackball, or a pointing stick for communicating direction information and command selections to the processor 113 and for controlling cursor movement on the display 120. In addition, a printer may provide printed listings of data stored and/or generated by the computer system 111.

The computer system 111 performs a portion or all of the processing steps of the invention in response to the processor 113 executing one or more sequences of one or more instructions contained in a memory, such as the main memory 114. Such instructions may be read into the main memory 114 from another computer readable medium, such as a hard disk 117 or a removable media drive 118. One or more processors in a multi-processing arrangement may also be employed to execute the sequences of instructions contained in main memory 114. In alternative embodiments, hard-wired circuitry may be used in place of or in combination with software instructions. Thus, embodiments are not limited to any specific combination of hardware circuitry and software.

As stated above, the computer system 111 includes at least one computer readable medium or memory for holding instructions programmed according to the teachings of the invention and for containing data structures, tables, records, or other data described herein. Examples of computer readable media are compact discs, hard disks, flash memory, PROMs (EPROM, EEPROM, flash EPROM), DRAM, SRAM, SDRAM, or any other magnetic medium, compact discs (e.g., CD-ROM), or any other optical medium, a carrier wave (described below), or any other medium from which a computer can read.

Stored on any one or on a combination of computer readable media, the present invention includes software for controlling the computer system 111, for driving a device or devices for implementing the invention, and for enabling the computer system 111 to interact with a human client. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 113 for execution. A computer readable medium may take many forms, including but not limited to, non-volatile media, volatile media, and transmission media. Non-volatile media includes, for example, optical, magnetic disks, and magneto-optical disks, such as the hard disk 117 or the removable media drive 118. Volatile media includes dynamic memory, such as the main memory 114. Transmission media includes coaxial cables, copper wire and fiber optics, including the wires that make up the bus 112. Transmission media also may also take the form of acoustic or light waves, such as those generated during radio wave and infrared data communications.

Various forms of computer readable media may be involved in carrying out one or more sequences of one or more instructions to processor 113 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 111 may receive the data on the telephone line and use an infrared transmitter to convert the data to an infrared signal. An infrared detector coupled to the bus 112 can receive the data carried in the infrared signal and place the data on the bus 112. The bus 112 carries the data to the main memory 114, from which the processor 113 retrieves and executes the instructions. The instructions received by the main memory 114 may optionally be stored on storage device 117 or 118 either before or after execution by processor 113.

The computer system 111 also includes a communication interface 123 coupled to the bus 112. The communication interface 123 provides a two-way data communication coupling to a network link 124 that is connected to, for example, a local area network (LAN) 125, or to another communications network 126 such as the Internet. For example, the communication interface 123 may be a network interface card to attach to any packet switched LAN. As another example, the communication interface 123 may be a wireless link. In any such implementation, the communication interface 123 sends and receives electrical, electromagnetic or optical signals that carry digital data streams representing various types of information.

The network link 124 typically provides data communication through one or more networks to other data devices. For example, the network link 124 may provide a connection to another computer or remotely located presentation device through a local network 125 (e.g., an 802.11-compliant wireless network) or through equipment operated by a service provider, which provides communication services through a communications network 126. In preferred embodiments, the local network 124 and the communications network 126 preferably use electrical, electromagnetic, or optical signals that carry digital data streams. The signals through the various networks and the signals on the network link 124 and through the communication interface 123, which carry the digital data to and from the computer system 111, are exemplary forms of carrier waves transporting the information. The computer system 111 can transmit and receive data, including program code, through the network(s) 125 and 126, the network link 124 and the communication interface 123. Moreover, the network link 124 may provide a connection through a LAN 125 to a mobile device 127 such as a personal digital assistant (PDA) laptop computer, or cellular telephone. The LAN communications network 125 and the communications network 126 both use electrical, electromagnetic or optical signals that carry digital data streams. The signals through the various networks and the signals on the network link 124 and through the communication interface 123, which carry the digital data to and from the system 111, are exemplary forms of carrier waves transporting the information. The processor system 111 can transmit notifications and receive data, including program code, through the network(s), the network link 124 and the communication interface 123.

Other aspects of the invention may include data transmission and Internet-related activities. See Preston Gralla, How the Internet Works, Ziff-Davis Press (1996), which is hereby incorporated by reference into this patent application. Still other aspects of the invention may utilize wireless data transmission, such as those described in U.S. Pat. Nos. 6,456,645, 5,818,328 and/or 6,208,445, all of which are hereby incorporated by reference into this patent application.

Turning to FIG. 1b, and according to at least one exemplary embodiment, a computer-implemented system 150 for determining political representation is disclosed. System 150 may be accessible by a plurality of voter users 160 and a plurality of political figure users 170. System 100 may further include at least one database 180, wherein the database may be used by system 100 to store any desired information, for example, but not limited to, political issue information, voting district information, voter personal information, voter location information, voter preferences on political issues, political figure information, political figure stances on political issues, voter locations, and any other desired information.

Each voter user 160 may maintain a user account with system 150. Additionally, each user 160 may have their identity, as well as any other information, such as address or jurisdiction information, saved and verified as a part of their user account with system 150. For example, each user 160 may provide a credit card or some other form of verification information that may be used to verify their identity, their home location, and, if desired, a voting jurisdiction. This may be desirable to prevent possible fraud, the creation of multiple user accounts for the same individual or any influence on issues outside of a relevant jurisdiction. Further, home address information can be compared to districting maps stored in system 150 so as to properly mate each user 160 with the appropriate voting district. Furthermore, a plurality of political figure profiles may be present on database 180. A political figure may maintain a user account 170 with system 150. However, a profile may be maintained for the political figure whether or not the political figure has a user account. Voters and political figures may access system 150 via the internet, for example by logging in to a website or accessing the system via an app for a portable communications device.

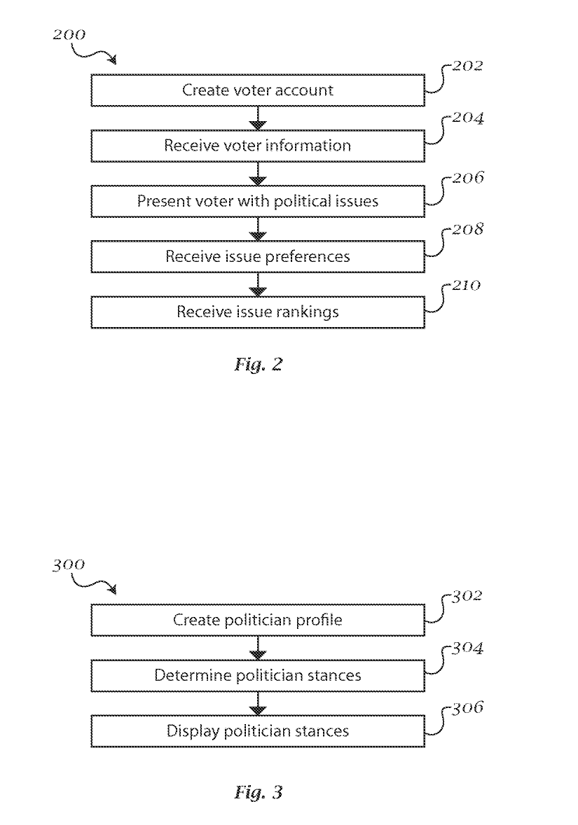

FIG. 2 shows an exemplary method for determining voter preferences. At step 202, a voter account may be created. At step 204, personal information of the voter may be received. The personal information may include the voter's name, address, contact information, voter registration information, voting districts, and any other relevant information. At step 206, the voter may be presented with one or more political issues. The political issues can include national, state, and local political issues. The voter may search for a particular political issue, or may be presented with a list of political issues, for example the issues that are prevalent in the voter's district. The system may compile a list of the political issues, for example by determining which issues are being discussed on various mass and social media, as well as by determining which issues are popular with other voter users in the voter's area, and/or the issues that other voter users in the voter's area have deemed to be important.

At step 208, the voter's preference regarding one or more political issue may be received. The voter may enter a response in any desired manner, for example by filling in a text field, or by choosing one of several preselected responses. The preselected responses may be any responses that are appropriate to the political issue, and may range from simple “yes”/“no”/“no opinion” responses to more nuanced or qualified responses.

At step 210, rankings of the political issues may be received from the voter. For example, the voter may rank all given political issues in order of importance to the voter. Alternatively, the voter may provide an importance level for each political issue, for example “most important”, “moderately important”, and “least important”.

FIG. 3 shows an exemplary method for determining a stance of a political figure. At step 302, a political figure profile may be created. The profile may be created upon request of a political figure, or may be generated by the system based on known political figures in a particular area.

At step 304, the political figure's stances on one or more political issues may be determined. The political issues can include national, state, and local political issues. The system may compile a list of the political issues, for example by determining which issues are being discussed on various mass and social media, as well as by determining which issues are popular with voter users in the political figure's area, and/or the issues that voter users in the political figure's area have deemed to be important.

The political figure's stances on one or more political issues may be determined in several manners. If the political figure wishes to participate in the system, the political figure may be presented with a political issue and prompted to enter a response. The political figure may enter a response in any desired manner, for example by filling in a text field, or by choosing one of several preselected responses. The preselected responses may be any responses that are appropriate to the political issue, and may range from simple “yes”/“no”/“no opinion” responses to more nuanced or qualified responses.

If the political figure does not wish to participate in the system, then the system may determine the political figure's stances based on known political activities of the political figure. Such political activities can include, for example, past voting history, political speeches given by the political figure, opinions expressed by the political figure in various media, and so forth.

At step 306, a page may be generated displaying the political figure's stances on the various issues. The page may be viewed by voter users of system 150 as well as by political figure users of system 150.

FIG. 4 shows an exemplary method for determining representation by a political figure of their constituency. At step 402, a list of political issues may be compiled. As above, the political issues can include national, state, and local political issues that may be important to the voters of a particular area or that are being discussed on various media.

At step 404, the aggregate political preferences of the political figure's constituency may be determined. These aggregate political preferences may be determined from the responses received by system 150 according to steps 206-210 of method 200.

At step 406, the aggregate political preferences of the constituency may be compared to the stance of the political figure on at least one issue. At step 408, the system may generate a page comparing the stance of the political figure to the aggregate political preferences of the constituency. The page may be viewed by voter users of system 150 as well as by political figure users of system 150.

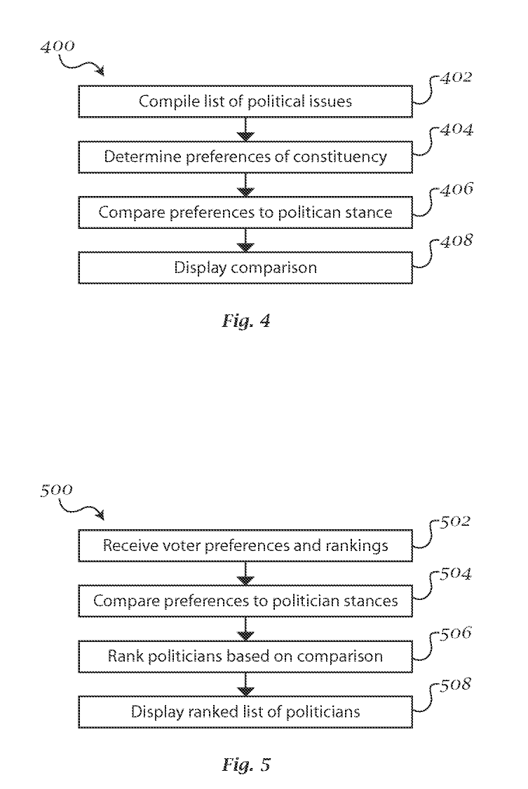

FIG. 5 shows an exemplary method of matching a voter to a political figure. At step 502, the voter's preferences regarding one or more political issue, as well as the voter's importance ranking of the issues may be received. At step 504, the preferences of the voter on each issue may be compared to the stances, on that issue, of political figures that are or intend to be representing the voter. At step 506, these political figures may be ranked based on a match between the voter preferences and the stances of the various political figures. The ranking of each political figure may be determined by the number of issues on which the voter and a political figure agree. The ranking may further be influenced by weighting various issues differently based on the importance that the voter assigns to the issues. Thus, for example, a political figure who matches the voter on a few “most important” issues may be ranked higher than a political figure who matches the voter on a greater number of “least important” issues.

Once the ranking is determined, the system may generate a page, at step 508, showing a ranked list of political figures as well as the political issues for which the voter's preferences have been received. An indication of whether each political figure matches or does not match the voter on a political issue may also be provided. The page may be viewed by a particular voter user of system 150.

Thus, the embodiments disclosed herein can aid voters in determining whether they are being properly represented by their elected candidates, as well as which candidate would best represent their views. The embodiments disclosed herein can also aid candidates and incumbents in determining whether their views reflect the views of their constituents.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A computer-implemented method for determining representation by political figures, comprising:
compiling a list of political issues;
receiving preferences of a plurality of voters for at least one issue in the list of political issues;
determining a stance of a political figure for the at least one issue; and
determining if the stance of the political figure matches a preference of the plurality of voters for the at least one issue.

2. The method of claim 1, wherein determining a stance of a political figure comprises receiving input, from the political figure, regarding the stance of the political figure for the at least one political issue.

3. The method of claim 1, wherein determining a stance of a political figure comprises gathering information from political activities of the political figure.

4. The method of claim 1, further comprising displaying a comparison of the stance of the political figure to the preferences of the plurality of voters.

5. The method of claim 1, further comprising determining if the stance of the political figure matches a preference of a voter of the plurality of voters.

6. The method of claim 5, further comprising displaying a comparison of the stance of the political figure to the preference of the voter.

7. A computer-implemented method for matching a voter and a political figure, comprising:
receiving a plurality of political issues from a voter;
receiving preferences of the voter for at least one political issue of the plurality of political issues;
receiving importance rankings for at least one political issue of the plurality of political issues;
determining stances of a plurality of political figures for at least one political issue of the plurality of political issues;
determining matches between the preferences of the voter and the stance of each political figure of the plurality of political figures; and
providing a ranking to the voter for each political figure based on the matches.

8. The method of claim 7, wherein determining stances of a plurality of political figures comprises receiving input, from each political figure, regarding the stance of the political figure for the at least one political issue.

9. The method of claim 7, wherein determining stances of a plurality of political figures comprises gathering information from political activities of each political figure.

10. A computer-implemented system for determining political representation, comprising:
a database;
a plurality of voter accounts;
a plurality of political figure accounts;
political issue data; and
at least one processor programmed with instructions such that the system is operable to receive preferences of at least one voter for at least one political issue and to determine a stance of at least one political figure for the at least one issue.

11. The system of claim 10, wherein the system is further operable to determine if the stance of the at least one political figure for the at least one issue matches a preference at least one voter for the at least one issue.

12. The system of claim 10, wherein the system is further operable to:
receive importance rankings for at least one political issue of the plurality of political issues, determine stances of a plurality of political figures for at least one political issue of the plurality of political issues, determine matches between the preferences of a voter and the stance of each political figure of the plurality of political figures; and provide a ranking to the voter for each political figure based on the matches.

13. The system of claim 10, wherein the stance of the political figure is determined by receiving input, from the political figure, regarding the stance of the political figure for the at least one political issue.

14. The system of claim 10, wherein the stance of the political figure is determined by gathering information from political activities of the political figure.

15. The system of claim 10, wherein the system is further operable to display a comparison of the stance of the political figure to the preferences of a plurality of voters.

16. The system of claim 10, wherein the system is further operable to display a list of ranked political figures based on the preferences of a voter.
